(19) United States
(12) Patent Application Publication
(10) Pub. No.: US 2024/0304988 A1
(43) Pub. Date: Sep. 12, 2024

(54) CABLELESS ANTENNA ARRAY

(71) Applicant: JOHN MEZZALINGUA ASSOCIATES, LLC., Liverpool, NY (US)

(72) Inventors: Taehee JANG, Allen, TX (US); Gilberto Guerra ARIAS, McKinney, TX (US); Jordan RAGOS, Dallas, TX (US)

(21) Appl. No.: 18/599,851

(22) Filed: Mar. 8, 2024

Related U.S. Application Data
(60) Provisional application No. 63/489,565, filed on Mar. 10, 2023.

(51) Int. Cl. H01Q 3/30; H01Q 3/02; H01Q 15/14; H01Q 21/06

(52) U.S. Cl. CPC H01Q 3/30; H01Q 3/02; H01Q 15/14; H01Q 21/062; H01Q 21/065

(57) ABSTRACT

An antenna array comprises a reflector and a plurality of columns of unit cells disposed on a first side of the reflector, each of the unit cells having a plurality of radiating elements. Disposed on a second side of the reflector is a plurality of phase shifter boards that are mounted perpendicular to the reflector. Each of the phase shifter boards has a plurality of traces, each of which are coupled directly to corresponding unit cells. An advantage of the disclosed antenna array is that it requires no cables for connection between the phase shifter boards and the radiating elements.

### CROSS-REFERENCE TO RELATED APPLICATIONS

This application claims the benefit of U.S. Provisional Application No. 63/489,565, filed on Mar. 10, 2023, all of which are incorporated by reference in their entirety herein.

### BACKGROUND OF THE INVENTION

Current cellular antennas typically operate in multiple frequency bands. For each supported frequency band, the antenna might have an array of radiating elements. The array of radiating elements may have multiple columns whereby each column may operate independently (each with its own RF (Radio Frequency) signals) or together whereby the entire array may operate on a single set of RF signals (typically two signals, one per polarization, such as +/−45 degrees). For either of these array configurations, it is typically required that the beam formed by the array be able to tilt in the vertical direction. This is done by a Remote Electrical Tilt (RET) mechanism that includes a dedicated phase shifter device for each column of radiating elements.

As these cellular antennas take on this complexity, an issue arises from all of the cables (and thus cable interconnects) required to couple each of the radiating elements of the array to their corresponding phase shifter boards. The increase in cabling leads to several disadvantages: (1) increased manufacturing complexity due to the need to solder all of the cables into place; and (2) the risk of signal degradation at each of these cable interconnects, which usually occurs in the form of Passive Inter-Modulation distortion (PIM) and loss due to impedance mismatch.

Accordingly, what is needed is an antenna array that provides RET features for all of the array columns while obviating the need for additional cabling between the radiating elements and their respective phase shifters.

### SUMMARY OF THE INVENTION

An aspect of the present disclosure involves an antenna array. The antenna array comprises a plurality of columns of unit cells disposed on a first side of the reflector, each of the plurality of unit cells having a plurality of radiating elements; a plurality of phase shifter boards disposed on a second side of the reflector, each of the plurality of phase shifter boards corresponding to one of the plurality of columns of unit cells, wherein each of the plurality of unit cells has a feed point that mechanically couples to its corresponding phase shifter board; and a phase shifter drive mechanism disposed on the second side of the reflector, wherein the phase shifter drive mechanism is mechanically coupled to each of the plurality of phase shifter boards.

### BRIEF DESCRIPTION OF DRAWINGS

FIG. 1A illustrates the topside of an exemplary antenna array according to the disclosure.

FIG. 1B is a plan view of a topside of the antenna array of FIG. 1A.

FIG. 2A illustrates an underside of an exemplary antenna array according to the disclosure.

FIG. 2B is a plan view of the underside of FIG. 2A.

FIG. 3 is a view of an exemplary antenna array from along a vertical axis.

FIG. 4 is a view of the exemplary antenna array from along a horizontal axis.

FIG. 5 illustrates and exemplary phase shifter board of the disclosure, including a plurality of radiating element coupling structures.

FIG. 6A illustrates an exemplary radiating element feed point structure before being soldered.

FIG. 6B illustrates the exemplary radiating element feed point structure of FIG. 6A but with solder applied.

FIG. 6C is a cross sectional view of the exemplary radiating element feed point structure of FIG. 6B.

FIG. 7A illustrates an exemplary phase shifter drive mechanism according to the disclosure.

FIG. 7B is another view of the exemplary phase shifter drive mechanism of FIG. 7A.

FIG. 7C is another view of the exemplary phase shifter drive mechanism of FIG. 7A.

FIG. 7D is a view of the exemplary phase shifter drive mechanism of FIG. 7A, viewed along a horizontal axis.

FIG. 7E is a view of the exemplary phase shifter drive mechanism of FIG. 7A, viewed along a vertical axis.

### DETAILED DESCRIPTION OF THE INVENTION

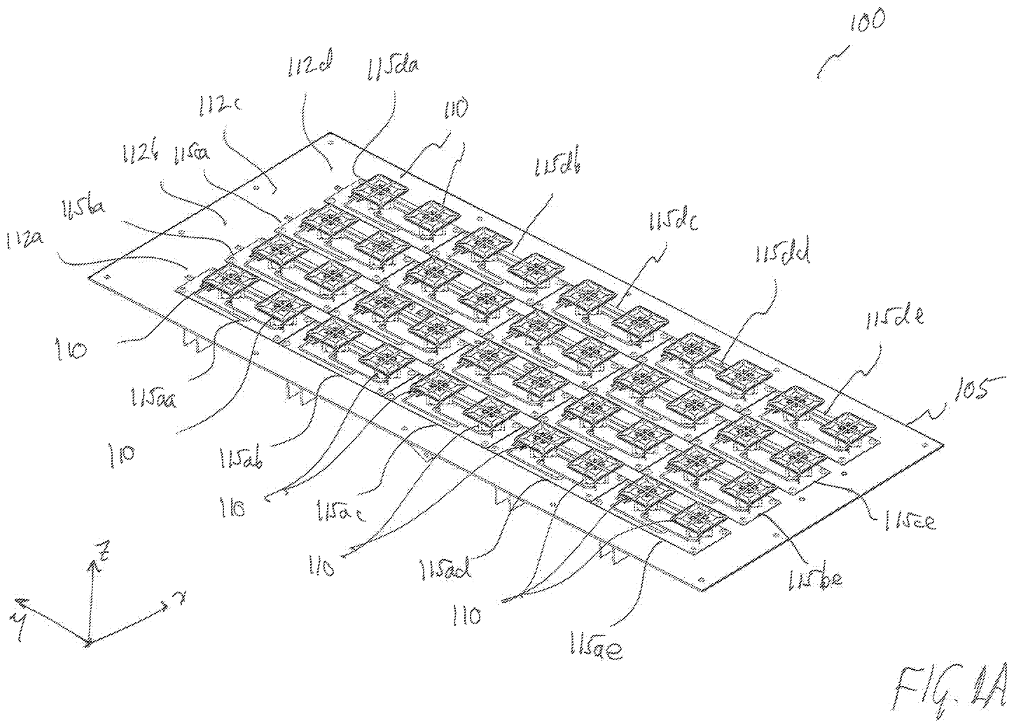

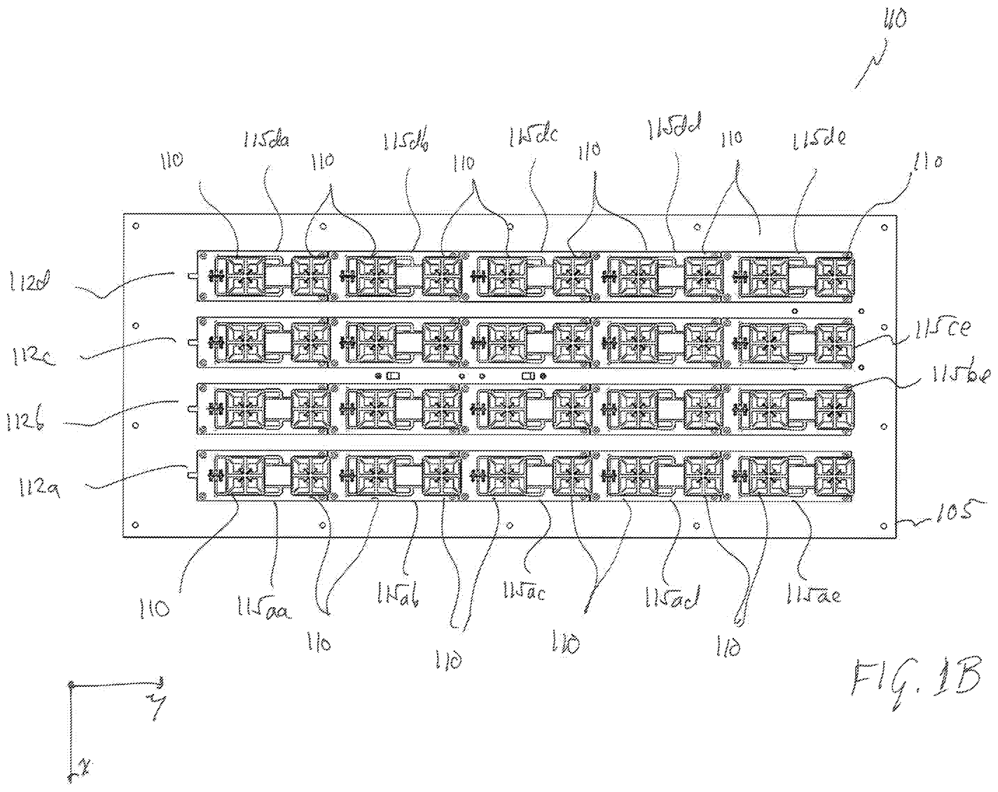

FIG. 1A illustrates a topside of exemplary antenna array 100 of the disclosure. Antenna array 100 has a reflector 105. Disposed on the topside of reflector 105 is a plurality of unit cells 115 arranged in an array of radiating element columns 112a-d along the horizontal or x-axis. First radiating element column 112a has five unit cells 115aa, 115ab, 115ac, 115ad, and 115ae; second radiating element column 112b has unit cells 115ba, 115bb, 115bc, 115bd, and 115be; third radiating element column 112c has unit cells 115ca, 115cb, 115cc, 115cd, and 115ce; and fourth radiating element column 112d has unit cells 115da, 115db, 115dc, 115dd, and 115de. Each unit cell 115 has two radiating elements 110.

Radiating elements 110 may be configured to operate in a given frequency band, such as mid band (MB)(1695-2690 MHz), C-Band and CBRS (Citizens Broadband Radio Service)(3.4-4.2 GHz). Further, radiating elements 110 may be dipoles or patch antenna elements. It will be understood that such variations are possible and within the scope of the disclosure.

Further illustrated in FIG. 1A is a coordinate frame. The y-axis may be referred to as the vertical or tilt axis, and the x-axis may be referred to as the horizontal axis. A plane defined by the x-axis and the z-axis may be referred to as the azimuth plane.

FIG. 1B is a view of the topside of antenna array 100 along the negative z-axis. As illustrated, radiating element columns 112a-d extend along the vertical or y-axis and are arranged side by side along the horizontal or x-axis.

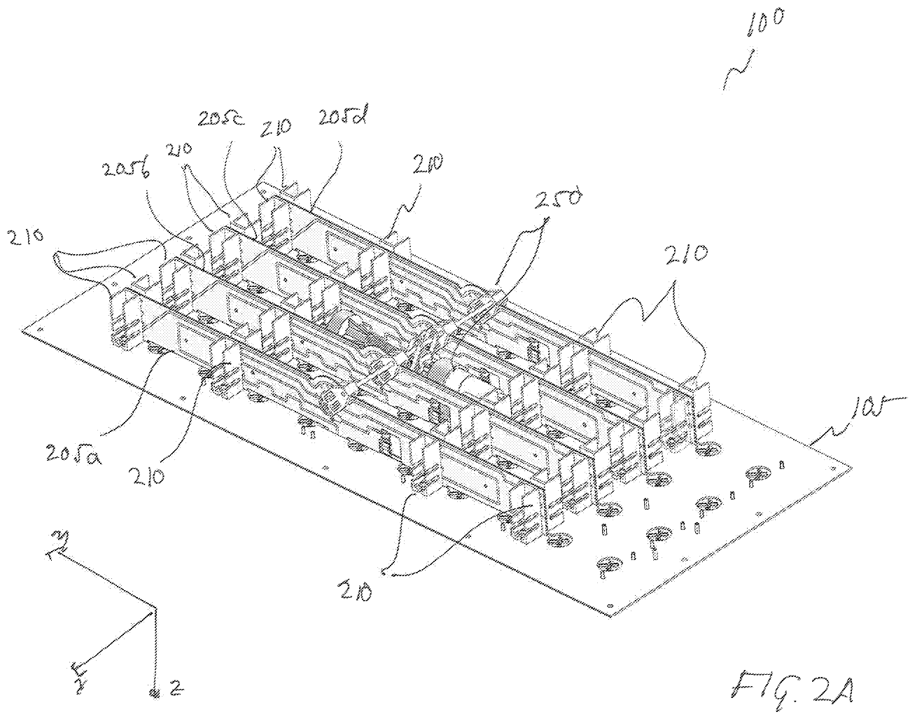

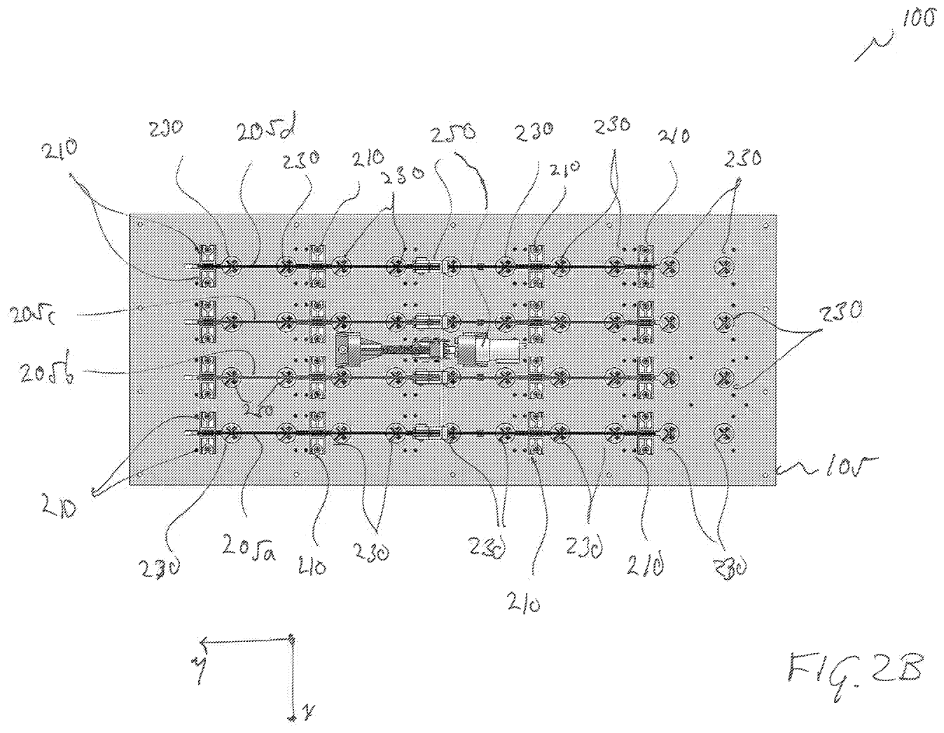

FIG. 2A illustrates an underside of exemplary antenna array 100. Disposed on the underside of reflector 105 are a plurality of phase shifter boards 205 whereby phase shifter board 205a corresponds to radiating element column 112a; phase shifter board 205b corresponds to radiating element column 112b; phase shifter board 205c corresponds to radiating element column 112c; and phase shifter board 205d corresponds to radiating element column 112d. Phase shifter boards 205 are mechanically coupled to reflector 105 by a plurality of mounting clips 210. Also disposed on underside of reflector 105 is a phase shifter drive mechanism 250, which is described further below.

FIG. 2B is a view of the underside of antenna array 100 along the positive z-axis direction. Shown are the four phase shifter boards 205a-d affixed within their respective mounting clips 210. Also shown are a plurality of stem plate apertures 230 that accommodate the balun stem plates of each of the radiating elements 110 (not shown in FIG. 2B). Also shown is phase shifter drive mechanism 250.

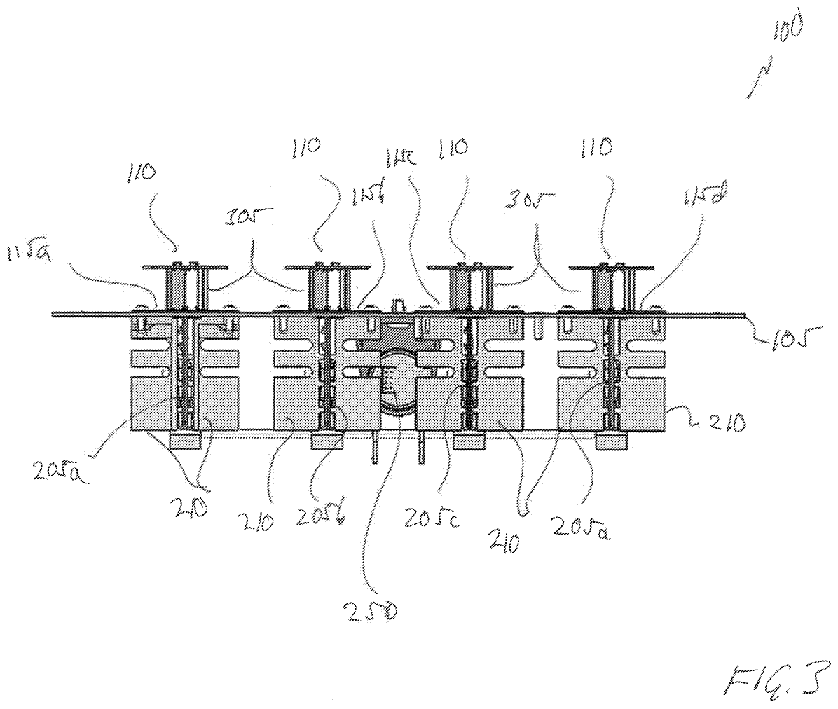

FIG. 3 illustrates exemplary antenna array 100 along the positive y-axis. Shown are reflector 105, and phase shifter boards 205a-d that are shown edge on and affixed within respective mounting clips 210. Coupled to phase shifter boards are corresponding radiating elements 110 of radiating element columns 112a-d, including radiating element balun stems 305, which mechanically couple radiating elements 110 to their respective unit cell 115 and electrically couple radiating elements 110 to their respective contacts of corresponding phase shifter board 205. Also illustrated is phase shifter drive mechanism 250 having a drive shaft 310.

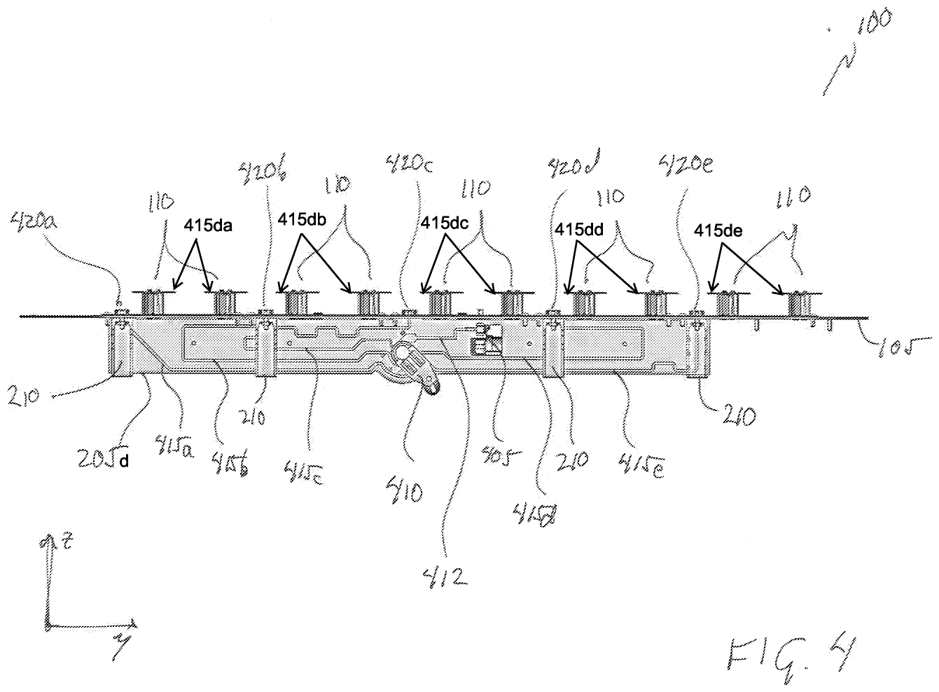

FIG. 4 illustrates antenna array 100 viewed along the positive x-axis. Shown is phase shifter board 205d (the other phase shifter boards 205 are obscured by it at this angle), which is affixed to reflector 105 by mounting clips 210. Visible on phase shifter board 205d is phase shifter wiper 410 and feed trace 412, which couples phase shift wiper 410 to signal input 405. Also coupled to phase shift wiper 410 are a first trace 415a that electrically couples to the two radiating elements 110 of unit cell 415da; a second trace 415b that electrically couples to the two radiating elements 110 of unit cell 415db; a third trace 415c that electrically couples to the two radiating elements 110 of unit cell 415dc; a fourth trace 415d that electrically couples to the two radiating elements 110 of unit cell 415dd; and a fifth trace 415e that electrically couples to the two radiating elements 110 of unit cell 415de.

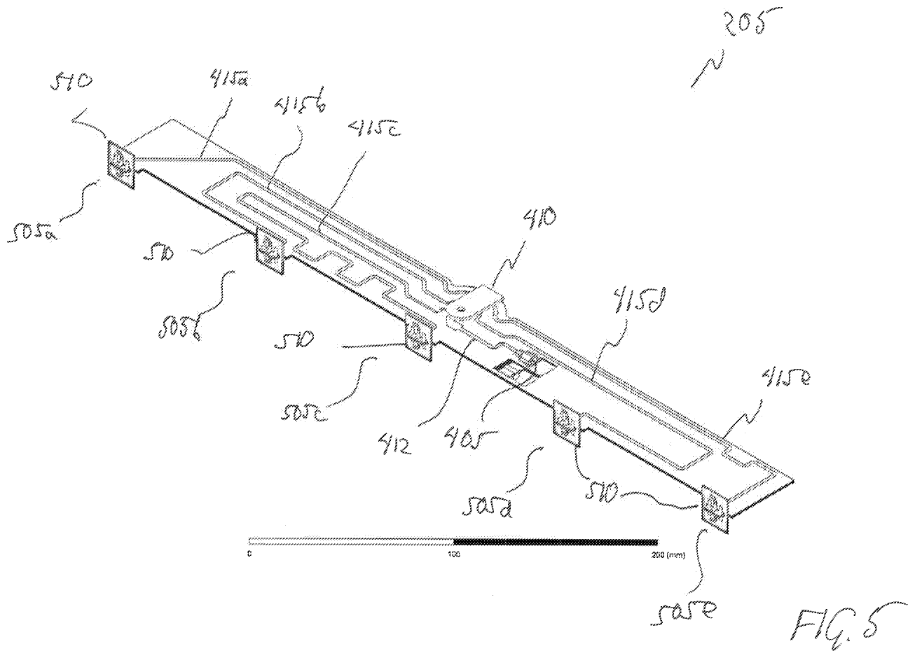

FIG. 5 illustrates an exemplary phase shifter board 205, showing traces 415a-e described above, and phase shifter wiper 410 illustrated in the neutral position. Further illustrated are five radiating element feed points 505, whereby feed point 505a is mechanically coupled to phase shifter board 205 and electrically coupled to first trace 415a; feed point 505b is mechanically coupled to phase shifter board 205 and electrically coupled to first trace 415b; feed point 505c is mechanically coupled to phase shifter board 205 and electrically coupled to first trace 415c; feed point 505d is mechanically coupled to phase shifter board 205 and electrically coupled to first trace 415d; and feed point 505e is mechanically coupled to phase shifter board 205 and electrically coupled to first trace 415e. As illustrated, feed points 505 are each disposed on a unit cell PCB 510, which is illustrated as a simple square shape. However, this is done for the convenience of illustration. Each unit cell PCB 510 is the actual PCB of a corresponding unit cell 115. The PCBs of each unit cell 115 are larger and rectangular, as illustrated in FIGS. 1A and 1B. The reduced area of PCBs 510 in FIG. 5 is done to prevent obscuring of the illustration of phase shifter board 205 in FIG. 5. It will be understood that each phase shifter board 205a-d is represented by FIG. 5. Phase shifter boards 205 may be multi-layered phase shifter boards whereby each layer has traces that carry signals for one of two polarization states. The respective length of each trace 415a-e provides differential phasing so that the combined radiated signal of radiating elements 110 form a high gain pattern in the vertical axis (y-axis).

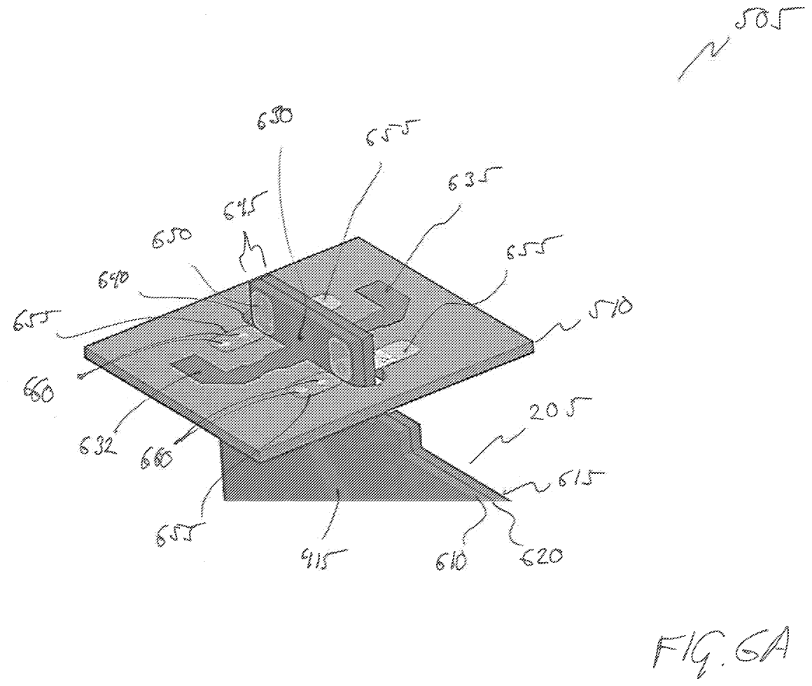

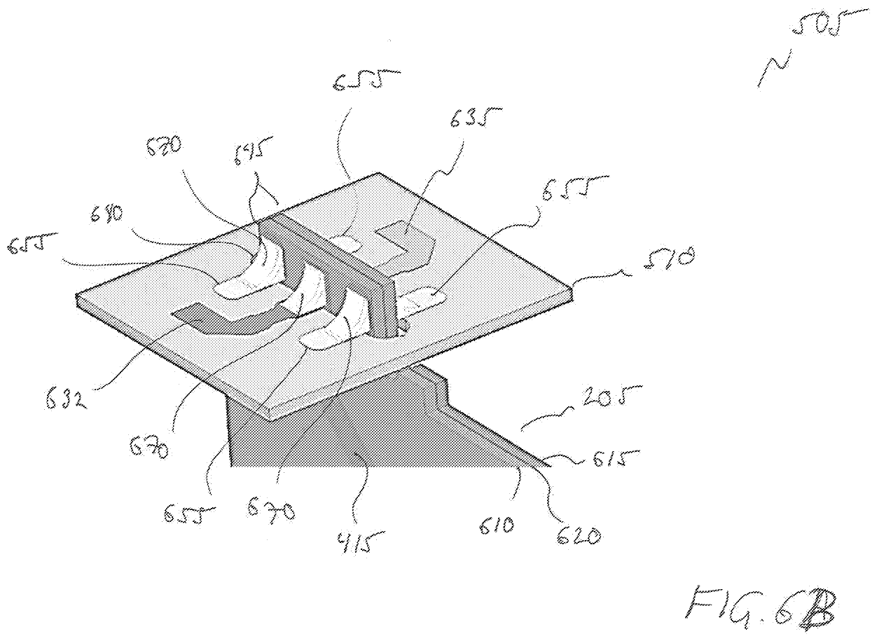

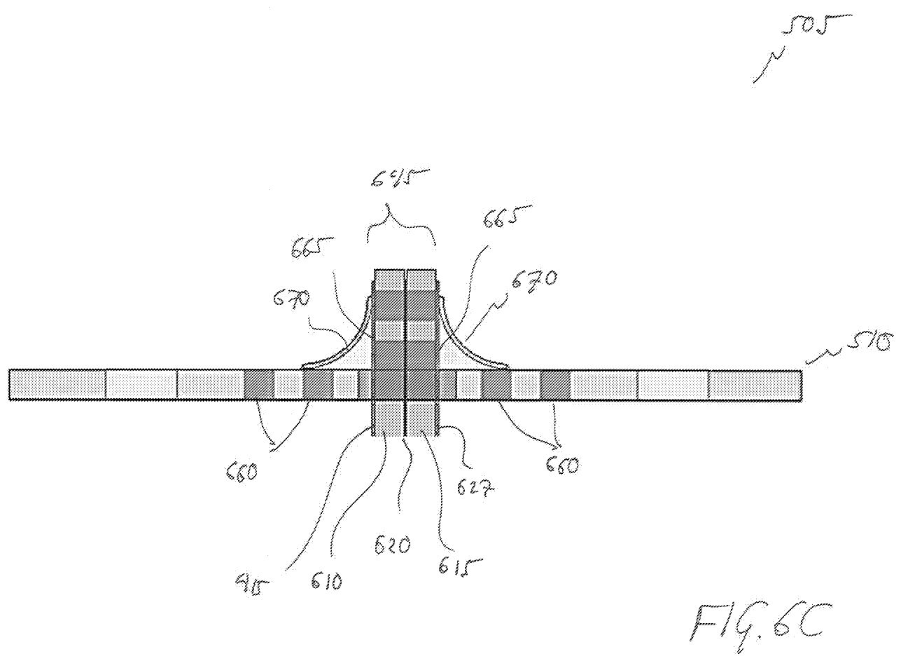

FIG. 6A illustrates an exemplary feed point structure 505 according to the disclosure. Feed point structure 505 has a unit cell PCB 510, which is shown here as an abbreviated square shape for purposes of illustration and may be instead the rectangular shape shown in FIGS. 1A and 1B. Unit cell PCB 510 has a slot 640 through which a tab portion 645 of phase shifter board 205 is inserted. As illustrated, phase shifter board 205 is a two-layer PCB that has a first layer 610 and a second layer 615, with a ground plane 620 disposed between them. Tab portion 645 has a set of vias (not shown) that couple the ground plane 620 to a plurality of solder pads 650 disposed on tab portion 645. Unit cell PCB 510 also has solder pads 655 that couple to vias 660 formed into unit cell PCB 510 for electrically coupling ground plane 620 to ground conductors (not shown) on the underside of unit cell PCB 510. Also disposed on tab portion 645 is a first signal solder pad 630, which couples a first signal trace 415 (in this example it could be any one of signal traces 415a-e) to a corresponding unit cell first signal trace 632 via a solder joint (not shown). As illustrated, a unit cell second signal trace 635 is disposed on unit cell PCB 510. Although not shown in FIG. 6A, disposed on the opposite side of tab portion 645—and disposed on second layer 615, is a second signal solder pad, which may be substantially similar to first signal solder pad (also not shown) and that couples a second signal to unit cell second signal trace 635.

FIG. 6B illustrates exemplary feed point structure 505, but with solder joints 670 applied to solder pads 650 and 655 to electrically couple the grounds; to separately couple first signal trace 415 to unit cell first signal trace 632 disposed on first layer 610; and to separately couple a second signal trace (not shown) disposed on second layer 615 to second unit cell signal trace 635.

FIG. 6C is a cross sectional view of feed point structure 505. Illustrated are unit cell PCB 510, and tab portion 645 of phase shifter board 205 mounted through slot 640 (not shown). Phase shifter board 205 has first layer 610 and a second layer 615, with ground plane 620 disposed between them. Disposed on first layer 610 is first signal trace 415, and disposed on second layer 615 is a second signal trace 627. Disposed within unit cell PCB 510 are vias 660, which couple the ground plane (not shown) disposed on the underside of unit cell PCB 510 to the corresponding solder joints 670 to vias 665 disposed in tab portion 645 to ground plane 620 disposed between first layer 610 and second layer 615 of phase shifter board 205.

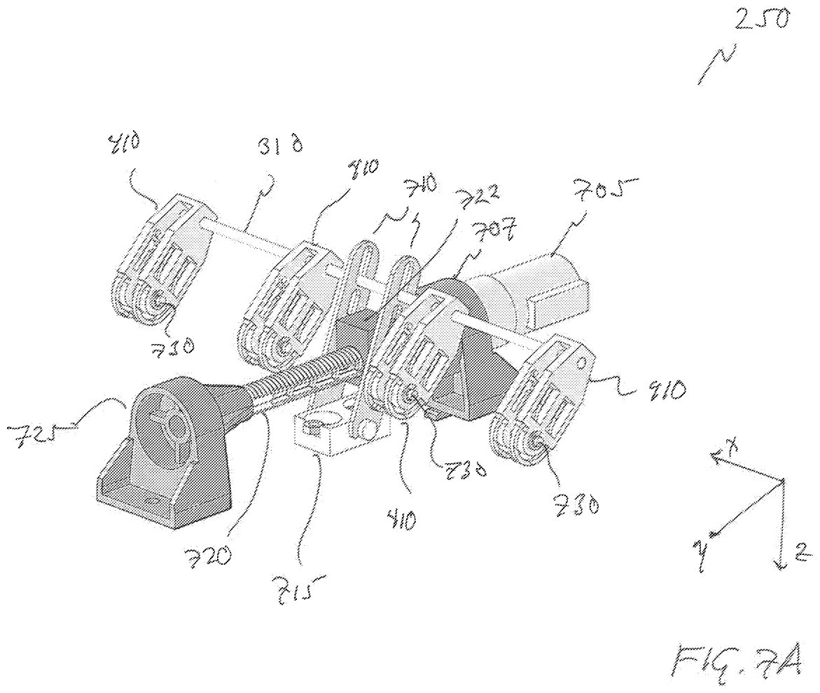

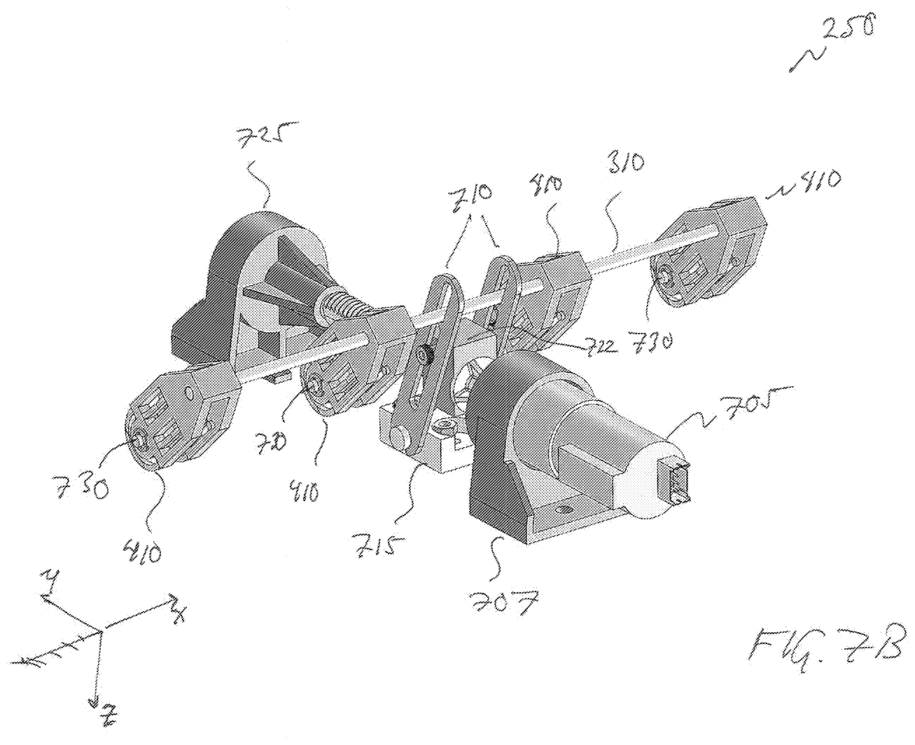

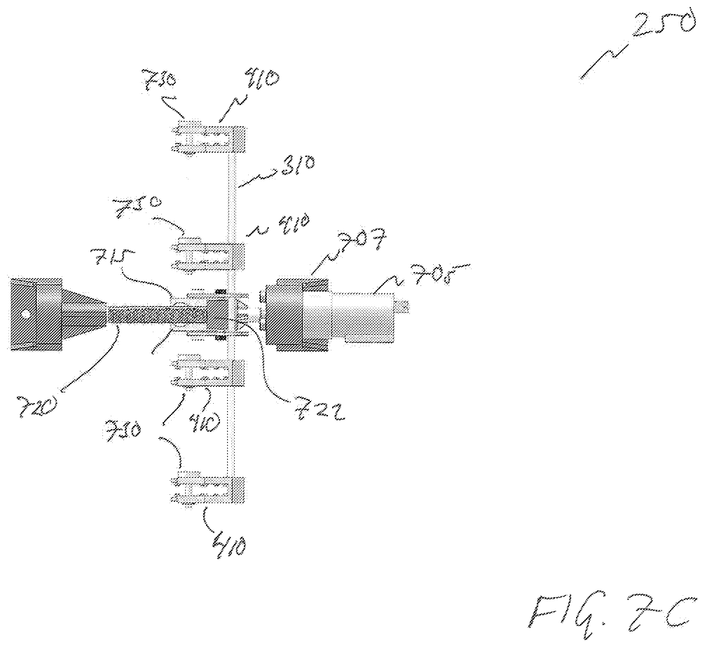

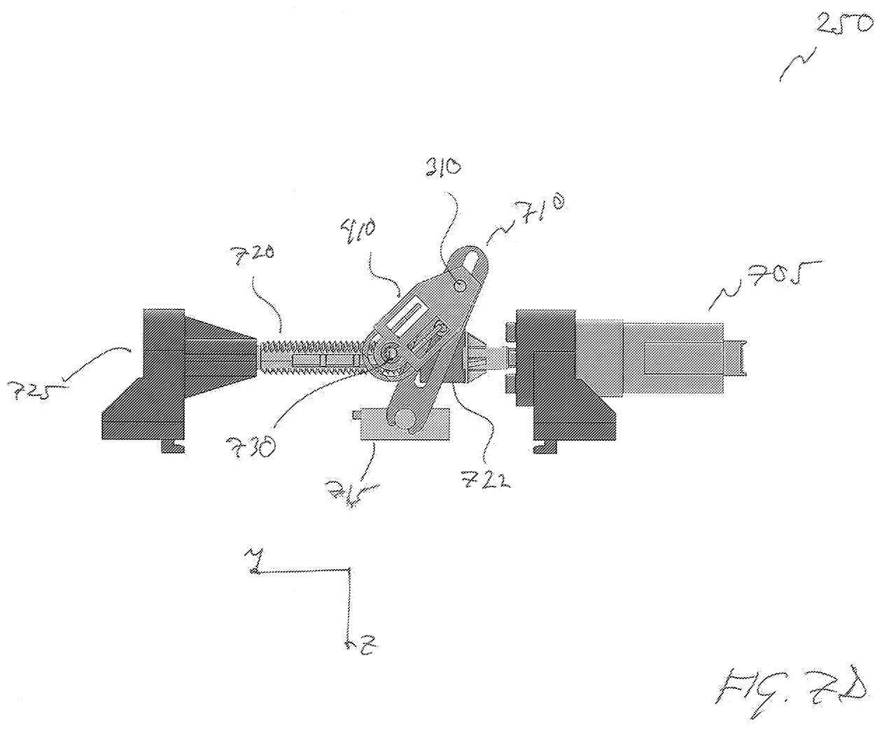

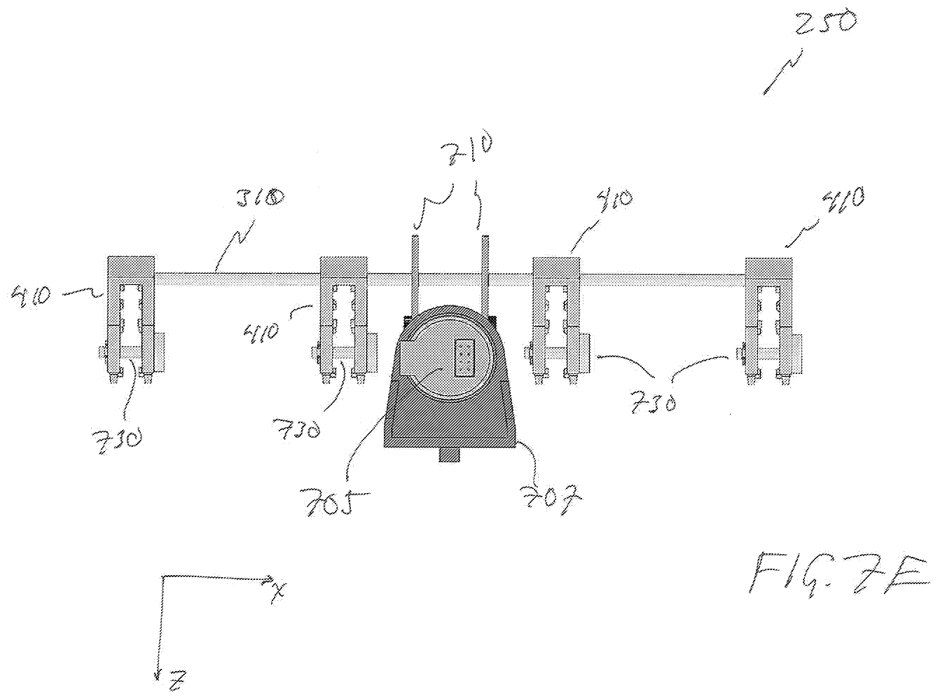

FIG. 7A illustrates an exemplary phase shifter drive mechanism 250 according to the disclosure. Phase shifter drive mechanism 250 has a drive motor 705 that is mounted to a first base 707. Mechanically coupled to drive motor 705 is a drive screw 720 that is rotatably mounted to first base 707 and a second base 725, both of which are mechanically coupled to reflector 105 (not shown). Also rotatably coupled to drive screw 720 is a block 722 that translates along the y-axis in both its positive and negative directions in response to rotation of drive screw 720 as driven by drive motor 705. Rotatably coupled to block 722 is a rotating bracket 710 that is rotatably mounted to a third base 715 that is mounted to reflector 105 (not shown). Coupled to rotating bracket 710 is a drive shaft 310. Drive shaft 310 is rotatably coupled to four phase shifter wipers 410, each of which has a pin 730 that gets inserted through corresponding phase shifter board 205 (not shown).

FIGS. 7A. 7B, 7C, 7D, and 7E provide views of phase shifter drive mechanism 250 from different orientations. Phase shifter drive mechanism 250 has a motor 705 that is mounted to a first base 707, which mounts to reflector 105 (not shown); a jack screw 720 that is mechanically coupled to motor 705 and rotatably coupled to second base 725, which is mounted to reflector 105 (not shown); a threaded block 722, which translates along the positive and negative y-axis direction in response to rotation of jack screw 720 around the y-axis; a rotating bracket 710 that is rotatably coupled to threaded block 722 and third base 715, which is mounted to reflector 105 (not shown). Rotatably and translationally coupled to rotating bracket 710 is a drive shaft 310. Rotatably coupled to drive shaft 310 are four wipers 410, each of which mechanically engage a corresponding phase shifter 205 via rotational axis pin 730.

Phase shifter drive mechanism 250 may operate as follows. Motor 705 engages drive screw 720, causing drive screw 720 to rotate around the y-axis. The rotation of drive screw 720 causes threaded block 722 to translate in the y-axis direction. The translation of threaded block 722 causes rotating bracket 710 to rotate around its axis coupled to third base 715, causing drive shaft 310 to translate in a plane defined by the y-axis and z-axis. The slots disposed within rotating bracket 710 engages with drive shaft 310 to translate in an arc within the plane, causing phase shifter wipers 410 to rotate around their respective axis pins 730 in unison. The rotation of phase shifter wipers 410 cause phase shifter boards 205 to impart a change in signal phases between phase shifter traces 415a, 415b, 415c, 415d, and 415e.

1. An antenna array, comprising:
a reflector;
a plurality of columns of unit cells disposed on a first side of the reflector, each of the plurality of unit cells having a plurality of radiating elements;
a plurality of phase shifter boards disposed on a second side of the reflector, each of the plurality of phase shifter boards corresponding to one of the plurality of columns of unit cells, wherein each of the plurality of unit cells has a feed point that mechanically and electrically couples to its corresponding phase shifter board; and
a phase shifter drive mechanism disposed on the second side of the reflector, wherein the phase shifter drive mechanism is mechanically coupled to each of the plurality of phase shifter boards.

2. The antenna array of claim 1, wherein each of the plurality of phase shifter boards is mounted perpendicularly to the reflector.

3. The antenna array of claim 2, wherein each of the phase shifter boards comprises:
a first PCB (Printed Circuit Board) layer having a first plurality of phase shifter traces;
a second PCB layer having a second plurality of phase shifter traces;
a phase shifter ground layer disposed between the first PCB layer and the second PCB layer; and
a tab portion.

4. The antenna array of claim 3, wherein each of the unit cells comprises:
a unit cell PCB having a slot and a plurality of unit cell ground vias;
a first unit cell trace disposed on a first side of the unit cell PCB;
a second unit cell trace disposed on the first side of the unit cell PCB; and
a unit cell ground layer disposed on a second side of the unit cell PCB.

5. The antenna array of claim 4, wherein each tab portion comprises:
a first plurality of phase shifter vias disposed in the first PCB layer, wherein the first plurality of vias expose the phase shifter ground layer;
a second plurality of phase shifter vias disposed in the second PCB layer, wherein the second plurality of vias expose the phase shifter ground layer;
a first trace solder pad disposed on the first PCB layer; and
a second trace solder pad disposed on the second PCB layer.

6. The antenna array of claim 5, wherein each of the unit cells is mechanically coupled to the tab portion of its corresponding phase shifter board.

7. The antenna array of claim 6, further comprising:
a first ground solder joint electrically coupling the unit cell ground layer to the phase shifter ground layer through a subset of the unit cell ground vias and the first plurality of phase shifter vias;
a second ground solder joint electrically coupling the unit cell ground layer to the phase shifter ground layer through a subset of the unit cell ground vias and the second plurality of phase shifter vias;
a first signal solder joint electrically coupling one of the first plurality of phase shifter traces to the first unit cell trace; and
a second signal solder joint electrically coupling one of the second plurality of phase shifter traces to the second unit cell trace.

8. The antenna array of claim 1, wherein the phase shifter drive mechanism comprises:
a drive motor mechanically coupled to a first base;
a jack screw rotatably coupled to the first base and a second base;
a threaded block coupled to the jack screw and configured to translate in response to rotation of the jack screw;
a rotating bracket rotatably coupled to the threaded block and rotatably coupled to a third base;
a drive shaft rotatably and translatably coupled to the rotating bracket; and
a plurality of wipers, each rotatably coupled to the drive shaft, wherein each of the plurality of wipers is rotatably coupled to a corresponding phase shifter board.

9. An antenna array, comprising:
a reflector;
a plurality of columns of unit cells disposed on a first side of the reflector, each of the plurality of unit cells having a plurality of radiating elements;
a plurality of phase shifter boards disposed on a second side of the reflector, each of the plurality of phase shifter boards corresponding to one of the plurality of columns of unit cells, wherein each of the plurality of unit cells of a given column of unit cells has a feed point that mechanically and electrically couples to their corresponding phase shifter board; and
a phase shifter drive mechanism disposed on the second side of the reflector, wherein the phase shifter drive mechanism is mechanically coupled to a plurality of phase shift wipers, and wherein each of the plurality of phase shift wipers is rotatably coupled to a corresponding one of the plurality of phase shifter boards and configured to electrically connect, to a signal input, each of the unit cells coupled to their corresponding phase shifter board.

10. The antenna array of claim 9, wherein each of the phase shifter boards comprises:
a first plurality of phase shifter traces on a first side of the phase shifter board, each electrically connected to a first radiating element of a corresponding one of the plurality of unit cells coupled to the phase shifter board, and
a second plurality of phase shifter traces on a second side of the phase shifter board, each electrically connected to a second radiating element of a corresponding one of the plurality of unit cells coupled to the phase shifter board.

11. The antenna array of claim 10, wherein each one of the plurality of phase shift wipers is configured to straddle a corresponding one of the plurality of phase shifter boards, and electrically connect the signal input to the first radiating element of each unit cell coupled to the corresponding phase shifter board via a corresponding one of the first phase shifter traces on the first side of the corresponding phase shifter board, and electrically connect the signal input to the second radiating element of each unit cell coupled to the corresponding phase shifter board via a corresponding one of the second phase shifter traces on the second side of the corresponding phase shifter board.

12. The antenna array of claim 11, wherein the first phase shifter traces carry signals having a first polarization state to the corresponding first radiating elements, and the second phase shifter traces carry signals having a second polarization state to the corresponding second radiating elements.

13. The antenna array of claim 11, wherein the phase shifter drive mechanism comprises a motor mechanically coupled to the plurality of phase shift wipers, the operation of the motor causing the plurality of phase shift wipers to simultaneously rotate to a same one of a plurality of positions relative to the first and second phase shifter traces.

14. The antenna array of claim 13, wherein the respective length of each of the first and second phase shifter traces, in conjunction with the position of the phase shift wipers relative to the first and second phase shifter traces provide differential phasing of the signal input for the radiating elements coupled to the first and second phase shifter traces.
